(19) United States
(12) Patent Application Publication
(10) Pub. No.: US 2026/0350727 A1
(43) Pub. Date: Nov. 5, 2026

(54) MACHINE LEARNING MODELS FOR CONTRACT ANALYSIS AND REVENUE DETERMINATION

(71) Applicant: BeatBread Limited, St. George, UT (US)

(72) Inventors: Izaic Max BLAZZARD; John L. HALLER, JR., St. George, UT (US); Peter SINCLAIR, San Marino, CA (US)

(21) Appl. No.: 19/366,065

(22) Filed: Oct. 22, 2025

Related U.S. Application Data
(60) Provisional application No. 63/767,433, filed on Mar. 5, 2025.

(51) Int. Cl. G06Q 50/18

(52) U.S. Cl. CPC G06Q 50/184

(57) ABSTRACT

Methods, devices, and systems directed to machine learning models for determining revenues and analyzing them through artist music contracts are disclosed. In an example aspect, a method for determining music artist compensation in multiple low, medium, and high performance scenarios for the artist's music tracks is described. First, a machine learning model predicts a distribution of future streams and royalties (or, more generally, revenue scenarios) for the music tracks. The method then flows these revenue scenarios through multiple contracts from different artist or label funding providers that outline monetary advances in exchange for the royalties associated with those music tracks. The method includes determining the artist's share of the royalties that the contracts allow in the different revenue scenarios. The method finally provides, via a user interface to the artist, a comparison of the share of royalties for each of the multiple contracts in each potential revenue scenario.

### CROSS-REFERENCE TO RELATED APPLICATION

This patent document is a non-provisional application that claims the benefit of priority to U.S. Provisional Application No. 63/767,433 filed Mar. 5, 2025. The contents of the above-noted applications are incorporated herein by reference in its entirety.

### TECHNICAL FIELD

This document generally relates to prediction of music value over a period of time using machine learning techniques.

### BACKGROUND

A majority of music consumption nowadays comes in the form of streaming services through one or more platforms, each of which provide a place where customers can come and stream music. Artists are then paid relative to the number of times each of their songs have been streamed, with the exact amount being based on the terms and conditions of the streaming service, the distributor and/or the label, and the artist's contracts.

### SUMMARY

Methods and systems related to training, configuring, and using machine learning models for contract analysis and revenue determination are described.

In the digital age, music rights management has started relying heavily on specialized computer systems, software applications, and data science for administering, tracking, and enforcing music copyright. Unlike traditional manual rights management, the digital domain deals with vast amounts of music data from platforms (e.g., Spotify, Apple Music), requiring scalable databases, secure servers, and programmatic rights enforcement tools.

The automation of critical processes such as rights metadata management, royalty calculation, payment tracking, and contract interpretation are enabled through the use of APIs, digital fingerprinting (e.g., audio watermarking), encrypted distribution, and blockchain-based recordkeeping. Additionally, platforms like Songtrust, Kobalt Music, and Vydia leverage machine-readable databases and proprietary algorithms to match song data with rights holders, automate royalty collection from hundreds of sources, and provide real-time analytics and dashboards to track financial performance. The reliance on technological innovations and machine-learning algorithms for complex data parsing, predictive modeling, and contract analytics demonstrates that digital music rights management goes well beyond legal or administrative activities.

Embodiments of the disclosed technology provide methods, systems, and user interfaces that utilize machine learning models to predict, analyze, and compare music artist compensation under different contract scenarios. Recognizing the growing complexity and opacity of modern music industry contracts—especially as streaming platforms and independent artist deals proliferate—the disclosed technology applies machine-learning to analyze large datasets composed of streaming metrics, artist popularity measures, social media data, and historical contract records. These models generate distributions of probable revenue outcomes for music tracks or catalogs, simulating a range of success scenarios. The predicted financial results are then mapped onto specific contract terms, such as royalties, advances, recoupable funding, distribution fees, and various deal structures found within the industry.

The described methods and systems employ natural language processing (NLP) to automatically extract and interpret contract clauses, which are then visually overlaid with projected revenue statistics for direct, scenario-based comparisons. The platform delivers an interactive user experience with features for inputting detailed deal terms, viewing side-by-side contract provisions, and exploring cashflows, payment timelines, recoupment schedules, and net present value projections. This empowers artists, labels, and rights holders to assess the real-world financial impacts of contract negotiations, make better-informed decisions, and gain transparency often lacking in traditional deal evaluations.

In an example aspect, a method for determining music artist compensation alternatives is disclosed. The method includes receiving, from a first machine learning model, for a music track or a music catalog of an artist, a distribution of predictions for the music track or the music catalog of the artist, and then receiving multiple contracts for the music track or the music catalog of the artist. In this example method, the distribution of predictions indicates a first range of potential revenue values associated with a low, medium, and high probability of success of the music track or the music catalog, and each contract of the multiple contracts comprises terms associated with determining a fractional value of a potential revenue value associated with the music track or the music catalog. The method further includes determining, using a second machine learning model, for each of the multiple contracts, the fractional value of the first range of potential revenue values that is owed to the artist based on the terms of a corresponding contract, generating, using the second machine learning model, a second range of potential revenue values for the artist based on the fractional value of the first range of potential revenue values, and providing, via a user interface to the artist, a comparison of the fractional value for each of the multiple contracts based on the second range of potential revenue values.

In another example aspect, a method for determining music artist compensation is disclosed. The method includes receiving, from a first machine learning model, for a music track or a music catalog of an artist, a distribution of predictions for the music track or the music catalog of the artist, and then receiving a contract for the music track or the music catalog of the artist. In this example method, the distribution of predictions indicates a first range of potential revenue values associated with a low, medium, and high probability of success of the music track or the music catalog, and the contract comprises terms associated with determining a fractional value of a potential revenue value associated with the music track or the music catalog. The method further includes determining, using a second machine learning model, the fractional value of the first range of potential revenue values that is owed to the artist based on the terms of the contract, generating, based on using the second machine learning model, a second range of potential revenue values for the artist based on the fractional value of the first range of potential revenue values, and providing, via a user interface to the artist, the second range of potential revenue values.

In yet another example aspect, a device is disclosed. The device includes at least one processor that is configured to implement an above-described methods.

In yet another example aspect, a computer-program storage medium is disclosed. The computer-program storage medium includes code stored thereon. The code, when executed by a processor, causes the processor to implement the above-described methods.

These, and other, aspects are described in the present document.

### BRIEF DESCRIPTION OF THE DRAWINGS

FIG. 1 illustrates an example process for an artist to receive payment for a piece of music, e.g., a track or mixtape, that the artist creates.

FIG. 2 illustrates an example architecture of a predictive model platform.

FIG. 3 illustrates an example machine learning or artificial intelligence (AI) system implementing one or more machine learning models.

FIG. 4 illustrates an example schematic diagram of applying the trained platform to analyze contracts and determine artist revenue.

FIG. 5 illustrates an example user interface for entering granular contract details.

FIG. 6 illustrates an example user interface for displaying side-by-side deal terms.

FIG. 7 illustrates an example user interface for displaying key financial statistics.

FIGS. 8A and 8B illustrate example user interfaces for displaying annual cashflow in a graph and a table, respectively.

FIGS. 9A and 9B illustrate example user interfaces for displaying cumulative cashflow to the artist or independent label in a graph or a table, respectively.

FIGS. 10A and 10B illustrate example user interfaces for displaying recoupment schedules in a graph and a table, respectively.

FIG. 11 illustrates an example user interface for displaying payment splits.

FIGS. 12A and 12B illustrate example user interfaces for annual and cumulative music performance predictions, respectively.

FIG. 13 is a flowchart representation of an example method for determining artist compensation for alternative contract arrangements.

FIG. 14 is a flowchart representation of an example method for determining artist compensation in view of an artist's music contract.

FIG. 15 is a block diagram that illustrates an example of a computer system in which at least some operations described herein can be implemented.

### DETAILED DESCRIPTION

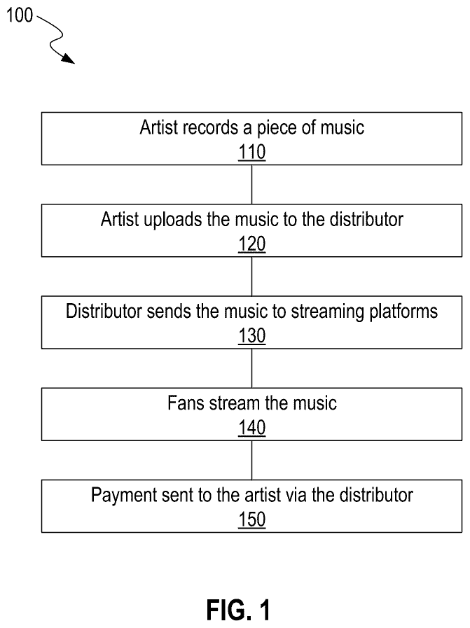

In the current music industry, a majority of music consumption comes in the form of streaming. Platforms such as Spotify, Apple Music, YouTube, Amazon and others provide a place where customers can come and stream music. Artists are then paid relative to the number of times each of their songs have been streamed. Often times, artists work with a company known as a distributor to get their music to a streaming platform. The distributor distributes their master recordings to the streaming platforms. Each master recording is given a unique identifying code known as an International Standard Recording Code (ISRC). The distributor not only distributes the recordings, but also collects royalties from the various streaming platforms. FIG. 1 illustrates an example process 100 for an artist to receive payment for a piece of music that the artist creates. In operation 110, an artist creates a piece of music. The artist uploads the recording of the music to a distributor in operation 120. In operation 130, the distributor sends the recording to the streaming platforms. Fans/customers then stream the music in operation 140 while the streaming platforms keep track of the number of streams that occur. In operation 150, the streaming platforms pay the distributor relative to the number of streams, and the distributor pays the artist. The artist now makes an income from their streamed music.

In this process, however, artists have very little idea about how much income their music can generate over a period of time. Previously in the industry, the label companies (or distributors) had the rights to royalties; they invested in, distributed and owned the music. However, the shift to streaming has been accompanied by a rise in independent artists and the disaggregation of ownership and/or distribution away from labels. Furthermore, music streaming platforms use a combination of algorithms and contractual agreements to determine the revenue share for artists and record labels from both subscription-based and ad-supported models.

The two common models specified in artists'contracts include the pro-rata model (most common, and used by major streaming platforms like Spotify, Apple Music, and Amazon Music) and the user-centric model. In the pro-rata model, the total revenue generated from subscriptions and advertisements is pooled together. The revenue pool is then distributed to rights holders (artists, songwriters, and record labels) based on their share of total streams on the platform. For instance, if an artist's music accounts for 1% of all streams in a given period, they receive 1% of the revenue pool. In contrast, in the user-centric model, the subscription fee paid by each user is distributed only to the artists they listen to. For example, if a user pays $10 per month and listens exclusively to one artist, that artist would receive the entire share of that user's subscription fee (minus the platform's cut).

Furthermore, current music contracts are highly complex due to the detailed and multifaceted terms they encompass. These contracts often include intricate clauses on intellectual property rights, royalty calculations, revenue-sharing agreements, and distribution terms. As discussed above, the rise of digital streaming has further complicated these agreements, introducing new metrics and models for revenue distribution. Additionally, contracts must address various rights, such as mechanical, performance, and synchronization rights, each with its own set of terms and conditions.

Independent artists and labels frequently struggle to understand the full financial implications of these agreements due to hidden fees, complicated recoupment structures, varying revenue splits, and an unclear projection of how their music will perform over the contract term. This lack of clarity poses significant challenges for artists and labels in making informed financial decisions, as they can be unaware of the potential outcomes of these deals. Currently, there are no tools available that allow users to input detailed contract terms and model their cashflows across different scenarios. This absence highlights the need for a system that assists artists and independent labels in understanding the long-term financial impacts of various deal terms in current music contracts.

This patent document discloses techniques that can be implemented in various embodiments to provide methods and systems for analyzing, comparing, and visualizing financial agreements for artists and independent labels to help them understand the short-and long-term implications of the various terms and conditions of different contracts. For example, an example embodiment parses and analyzes multiple contracts that may have significantly different contract terms in a way that allows the artist (or independent label) to perform an apples-to-apples comparison of these multiple contracts over both short-term and long-term horizons. By offering this detailed level of analysis and comparison, the described embodiments aim to inject much-needed transparency and clarity into the financial aspects of music deals. Consequently, artists and labels are empowered to make better-informed decisions, fostering a more equitable and comprehensible financial landscape within the music industry.

In some implementations of the disclosed techniques, a number of machine learning (ML) models are trained using datasets from thousands of artists and contracts. The datasets can include streaming metrics, artist metrics, social media metrics and other metrics. They can also include both historical contracts and contract templates that enable ML models to parse bespoke contracts to extract industry-standard terms and conditions that can be compared. The machine learning models can be trained using a variety of loss functions, with different values assigned to the different loss functions to generate a distribution of predictions, which is unlike other systems that rely on single-valued (e.g., average value) predictions. In some examples, these predictions, in the form of cashflows, can then be used to indicate the scale of variability of performance for an artist. Given the distribution of predictions, artists and independent labels can determine the expected cashflow in both short-term and long-term horizons for a variety of scenarios that are representative of different levels of success for the artist. The extracted terms from multiple contracts can be overlaid on the distribution of predictions to provide an estimate of the revenue owed to the artist based on the terms of each contract being considered.

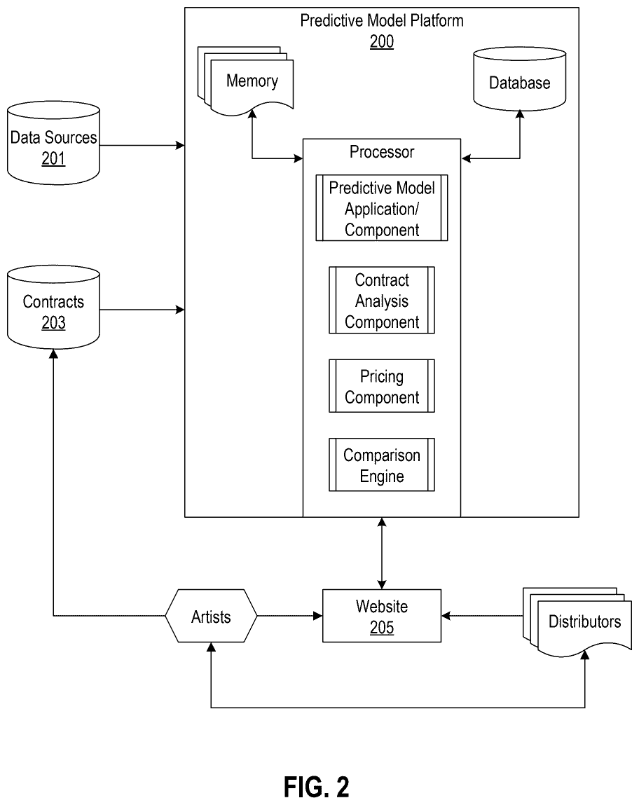

FIG. 2 illustrates an example architecture of a predictive model platform 200. The predictive model platform 200 receives input from data sources 201 (e.g., industry reports, trade publications, etc.) and a contract repository 203 (e.g., different contracts between artists and distributors, etc.), and is in communication with artists and/or distributors via a user interface 205 (e.g., one or more websites). The predictive model platform 200 comprises at least one memory and at least one processor that is configured to implement machine learning models. In some embodiments, the machine learning models include at least a predictive model component, a contract analysis component, a pricing component, and/or a comparison engine. Each of these components and the engine can be implemented as a software component with instructions (stored in the at least one memory) that are executed by the at least one processor.

In some examples, the predicative model component can provide a distribution of predictions for a track or a catalog. The distribution of predictions is associated with different likelihoods of having a particular number of streams in a predefined time period. The generation of the distribution of predictions, and the training datasets used therefor, are detailed in U.S. patent application Ser. No. 18/609,746, which is hereby incorporated by reference, in its entirety. The contract analysis engine can analyze the contracts of artists or independent labels, converting various industry-specific terms into a standardized format. This structured data can then be applied to forecasted cashflows (e.g., the distribution of predictions), providing a clear and consistent financial overview. In an example, natural language processing (NLP) can be used by the contract analysis engine to parse the contracts.

Based on the distributions and the terms of the contract determined by the contract analysis component, the comparison engine overlays the contractual terms on the predicted music cashflows to determine the amount owed to the artists. The comparison engine can use a set of instructions (e.g., Python scripts) to interpret various deal terms, apply logic, and determine how each dollar of revenue is split. Then, the pricing component can generate the revenue owed to the artist. For example, the pricing component can determine a range of potential outcomes for the artist based on the distribution of predictions. The predictive model evaluates the performance of the given artist in different scenarios (e.g., a number of individual songs and/or a catalog of songs of the artist) and for the different contracts being considered. The user interface 205 can be used to present this information to the artist or independent label.

Embodiments of the disclosed technology provide an interface that facilitates the input of granular contract terms for various types of agreements, allowing users to meticulously detail each contract. Moreover, it enables the comparison of terms and key financial statistics side-by-side, empowering users to make informed decisions by evaluating different deals simultaneously. The embodiments incorporate interactive scenario-based comparisons, which allow users to assess each metric under varying performance levels. This feature enhances the understanding of potential outcomes by displaying different cashflow scenarios, aiding in the long-term impact assessment of deals. Additionally, the disclosed technology breaks down recoupment schedules, providing clarity on how each dollar is split among the contracting parties. Additionally, the system leverages the capabilities of the described ML models that parse music industry contracts and automatically populate terms into a standard quantitative structure, thereby enabling the comparison of terms and key financial statistics side-by-side.

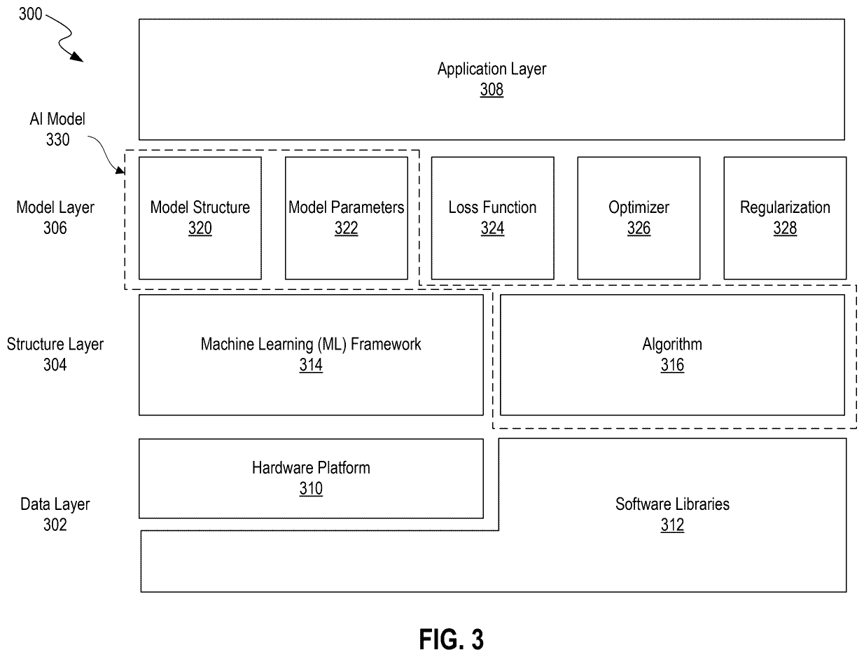

FIG. 3 illustrates an example machine learning or artificial intelligence (AI) system implementing one or more of the described machine learning models. As shown, the AI system 300 can include a set of layers, which conceptually organize elements within an example network topology for the AI system's architecture to implement a particular AI model 330. Generally, an AI model 330 is a computer-executable program implemented by the AI system 300 that analyses data to make predictions. Information can pass through each layer of the AI system 300 to generate outputs for the AI model 330. The layers can include a data layer 302, a structure layer 304, a model layer 306, and an application layer 308. The algorithm 316 of the structure layer 304 and the model structure 320 and model parameters 322 of the model layer 306 together form the example AI model 330. The optimizer 326, loss function engine 324, and/or regularization engine 328 work to refine and optimize the AI model 330, and the data layer 302 provides resources and support for application of the AI model 330 by the application layer 308.

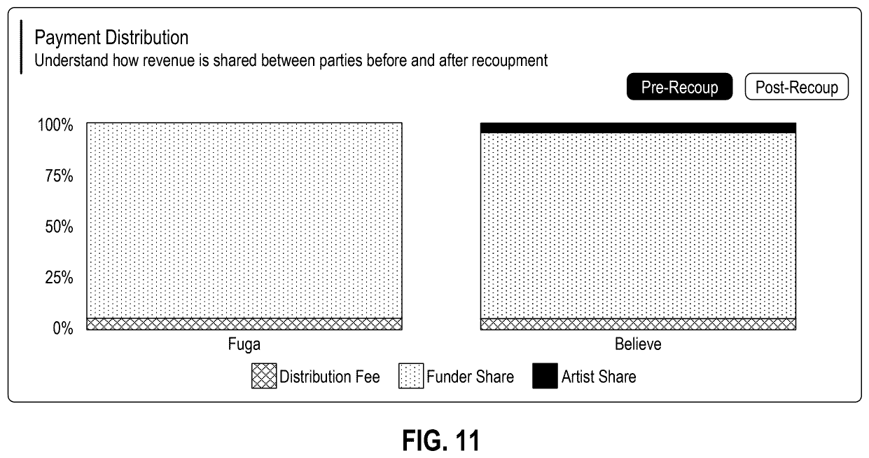

The data layer 302 acts as the foundation of the AI system 300 by preparing data for the AI model 330. As shown, the data layer 302 can include two sub-layers: a hardware platform 310 and one or more software libraries 312. The hardware platform 310 can be designed to perform operations for the AI model 330 and include computing resources for storage, memory, logic and networking, such as the resources described in relation to FIG. 11. The hardware platform 310 can process amounts of data using one or more servers. The servers can perform backend operations such as matrix calculations, parallel calculations, ML training, and the like. Examples of servers used by the hardware platform 310 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 310 can include Infrastructure as a Service (IaaS) resources, which are computing resources, (e.g., servers, memory, etc.) offered by a cloud services provider. The hardware platform 310 can also include computer memory for storing data about the AI model 330, application of the AI model 330, and training data for the AI model 330. The computer memory can be a form of random-access memory (RAM), such as dynamic RAM, static RAM, and non-volatile RAM.

The software libraries 312 can be thought of as suites of data and programming code, including executables, used to control the computing resources of the hardware platform 310. The programming code can include low-level primitives (e.g., fundamental language elements) that form the foundation of one or more low-level programming languages, such that servers of the hardware platform 310 can use the low-level primitives to carry out specific operations. The low-level programming languages do not require much, if any, abstraction from a computing resource's instruction set architecture, allowing them to run quickly with a small memory footprint. Examples of software libraries 312 that can be included in the AI system 300 include Intel Math Kernel Library, Nvidia cuDNN, Eigen, and Open BLAS.

The structure layer 304 can include an ML framework 314 and an algorithm 316. The ML framework 314 can be thought of as an interface, library, or tool that allows users to build and deploy the AI model 330. The ML framework 314 can include an open-source library, an application programming interface (API), a gradient-boosting library, an ensemble method, or a deep learning toolkit that work with the layers of the AI system facilitate development of the AI model 330. For example, the ML framework 314 can distribute processes for application or training of the AI model 330 across multiple resources in the hardware platform 310. The ML framework 314 can also include a set of pre-built components that have the functionality to implement and train the AI model 330 and allow users to use pre-built functions and classes to construct and train the AI model 330. Thus, the ML framework 314 can be used to facilitate data engineering, development, hyperparameter tuning, testing, and training for the AI model 330. Examples of ML frameworks 314 that can be used in the AI system 300 include TensorFlow, PyTorch, Scikit-Learn, Keras, Caffe, Light Gradient Boosting Machine (LightGBM), random forest, and Amazon Web Services (AWS).

The algorithm 316 can be an organized set of computer-executable operations used to generate output data from a set of input data and can be described using pseudocode. The algorithm 316 can include complex code that allows the computing resources to learn from new input data and create new/modified outputs based on what was learned. In some implementations, the algorithm 316 can build the AI model 330 through being trained while running computing resources of the hardware platform 310. This training allows the algorithm 316 to make predictions or decisions without being explicitly programmed to do so. Once trained, the algorithm 316 can run at the computing resources as part of the AI model 330 to make predictions or decisions, improve computing resource performance, or perform tasks. The algorithm 316 can be trained using supervised learning, unsupervised learning, semi-supervised learning, and/or reinforcement learning.

The model layer 306 implements the AI model 330 using data from the data layer, and the algorithm 316 and the ML framework 314 from the structure layer 304, thus enabling decision-making capabilities of the AI system 300. The model layer 306 includes a model structure 320, model parameters 322, a loss function engine 324, an optimizer 326, and/or a regularization engine 328.

The model structure 320 describes the architecture of the AI model 330 of the AI system 300. The model structure 320 defines the complexity of the pattern/relationship that the AI model 330 expresses. Examples of structures that can be used as the model structure 320 include decision trees, support vector machines, regression analyses, Bayesian networks, Gaussian processes, genetic algorithms, and artificial neural networks (or, simply, neural networks). The model structure 320 can include a number of structure layers, a number of nodes (or neurons) at each structure layer, and activation functions of each node. Each node's activation function defines how to node converts data received to data output. The structure layers may include an input layer of nodes that receive input data, an output layer of nodes that produce output data. The model structure 320 may include one or more hidden layers of nodes between the input and output layers. The model structure 320 can be an Artificial Neural Network (or, simply, neural network) that connects the nodes in the structured layers such that the nodes are interconnected. Examples of neural networks include Feedforward Neural Networks, convolutional neural networks (CNNs), Recurrent Neural Networks (RNNs), Autoencoder, and Generative Adversarial Networks (GANs).

The model parameters 322 represent the relationships learned during training and can be used to make predictions and decisions based on input data. The model parameters 322 can weight and bias the nodes and connections of the model structure 320. For instance, when the model structure 320 is a neural network, the model parameters 322 can weight and bias the nodes in each layer of the neural networks, such that the weights determine the strength of the nodes and the biases determine the thresholds for the activation functions of each node. The model parameters 322, in conjunction with the activation functions of the nodes, determine how input data is transformed into desired outputs. The model parameters 322 can be determined and/or altered during training of the algorithm 316.

The loss function engine 324 can determine a loss function, which is a metric used to evaluate the AI model's 330 performance during training. For instance, the loss function engine 324 can measure the difference between a predicted output of the AI model 330 and the actual output of the AI model 330 and is used to guide optimization of the AI model 330 during training to minimize the loss function. The loss function may be presented via the ML framework 314, such that a user can determine whether to retrain or otherwise alter the algorithm 316 if the loss function is over a threshold. In some instances, the algorithm 316 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The optimizer 326 adjusts the model parameters 322 to minimize the loss function during training of the algorithm 316. In other words, the optimizer 326 uses the loss function generated by the loss function engine 324 as a guide to determine what model parameters lead to the most accurate AI model 330. Examples of optimizers include Gradient Descent (GD), Adaptive Gradient Algorithm (AdaGrad), Adaptive Moment Estimation (Adam), Root Mean Square Propagation (RMSprop), Radial Base Function (RBF) and Limited-memory BFGS (L-BFGS). The type of optimizer 326 used may be determined based on the type of model structure 320 and the size of data and the computing resources available in the data layer 302.

The regularization engine 328 executes regularization operations. Regularization is a technique that prevents over-and under-fitting of the AI model 330. Overfitting occurs when the algorithm 316 is overly complex and too adapted to the training data, which can result in poor performance of the AI model 330. Underfitting occurs when the algorithm 316 is unable to recognize even basic patterns from the training data such that it cannot perform well on training data or on validation data. The regularization engine 328 can apply one or more regularization techniques to fit the algorithm 316 to the training data properly, which helps constraint the resulting AI model 330 and improves its ability for generalized application. Examples of regularization techniques include lasso (L1) regularization, ridge (L2) regularization, and elastic (L1 and L2 regularization).

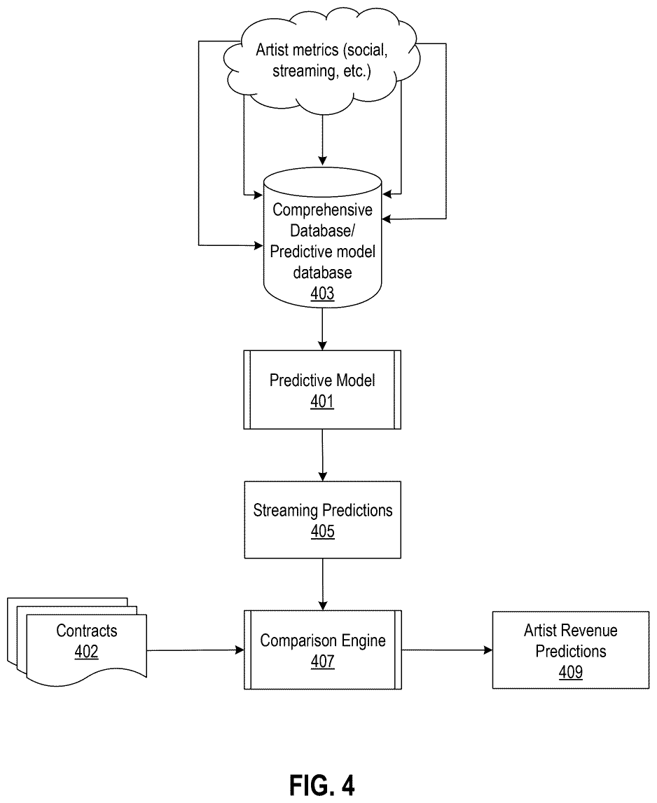

FIG. 4 illustrates an example schematic diagram of applying the trained platform for predictions using one or more of the described embodiments. Once trained, the predictive model(s) 401 takes the data stored in a comprehensive database 403 as the input data. The input data can include available metadata of a specified artist. A distribution of streaming predictions 405 can be generated by the predictive model(s) 401, predicting different percentiles in the range of probability for a track and/or tracks in a catalog with different characteristics, e.g., as detailed in U.S. patent application Ser. No. 18/609,746, the contents of which are incorporated herein by reference in their entirety. For example, the prediction model platform predicts future revenue at a track level (e.g., for each track in an album or catalog) or at a catalog (or mixtape) level and ties it all together to calculate the total future revenue estimate.

In some embodiments, the predicted revenue values can be determined based on the predicted number of streams for the music track(s)/music catalog, and using either the pro-rata royalty model or the user-centric royalty model (e.g., based on which one has been adopted by the specific streaming music platform). More complex calculation can also be adopted given the payment structure of different streaming services (e.g., based on the region of the music asset, whether promotional free streaming is available, etc.).

As shown in FIG. 4, the streaming predictions 405 are input into a comparison engine 407, which also receives the multiple contracts 402 being considered by the artist, and outputs a comparison of the artist revenue predictions 409 for each of the contracts. In some embodiments, the comparison engine 407 parses each of the multiple contracts to convert bespoke contract terms into industry-standard terminology, which can then be overlaid onto the distribution of streaming predictions to determine the artist revenue predictions 409 as a fractional portion of the total revenue of the streaming music platform (over a predetermined period of time). The comparison engine can use natural language processing, a rules-based framework, keyword extraction and analysis techniques, semantic analysis, or knowledge graphs to parse the contract between the artist and the distributor, producer, and other entities involved in music production.

In some embodiments, a machine learning model (e.g., predictive model(s) 401 in FIG. 4 or, more generally, predictive model platform 200 in FIG. 2) predicts a distribution of future streams and royalties (or, more generally, revenue scenarios, e.g., streaming predictions 405 in FIG. 4) for one or more of an artist's music tracks. The method further includes flowing these revenue scenarios through multiple contracts from different artist or label funding providers (e.g., contracts 402 in FIG. 4 or 203 in FIG. 2) that outline monetary advances in exchange for the royalties associated with those one or more tracks. The method then includes determining (e.g., using comparison engine 407 in FIG. 4) the artist's or label's share of the royalties that the contracts allow (e.g., artist revenue predictions 409 in FIG. 4) in the different revenue scenarios. The method finally includes providing, via a user interface to the artist (e.g., website 205 in FIG. 2), a comparison of these fractional royalties for each of the multiple contracts for each of the potential revenue scenarios.

As discussed earlier, current music contracts involve a plethora of terms associated with revenue division and distribution, which makes it very difficult for artists to determine how much their share will be in the short-term and/or the long-term. For example, using the pro-rata model versus the user-centric royalty for streaming royalties can significantly change the revenue the artist will receive. For example, the pro-rata royalty model is viewed as favoring more popular artists who rack of thousands (if not hundreds of thousands, or millions) of streams. In contrast, the user-centric model is viewed as being a more equitable distribution system for all artists, particularly those with niche audiences. And to further complicate the situation, certain streaming platforms (e.g., Tidal) use a direct-to-artist model where a portion of a subscriber's fee goes directly to artists (but may not include any portion of advertising revenues), whereas others (e.g., SoundCloud) use a fan-powered royalty where artists are paid based on how much their fans listen to their music. The described embodiments can determine and compare artist revenue predictions across multiple contracts, each of which may use a different streaming music royalty model, and taking into account variability of performance for the artist.

In another example, an artist is provided an advance amount that is offset by a future royalty stream expected by the artist. However, the portion of the future royalty stream that is allocated to paying off the advance amount is rarely, if ever, clearly specified in the contract. For example, the share of the royalty stream that is paying down the advance is based on other terms such as royalty rates, distributions fees, “profit splits”, etc. Some disclosed embodiments parse one or more contracts the artist is considering, flow the predicted revenue streams through the one or more contracts, and provide (e.g., via a website or graphical user interface) the artist with an “effective recoupment rate” comparison across the one or more contracts.

In yet another example, an artist can receive multiple (or additional) advances, each of which may define a new term that the future royalty stream must offset. Some disclosed embodiments generate the predicted revenue streams for short-and long-term horizons, thereby enabling the artist to determine their share of the future royalty stream in view of the multiple advances they have received (and likely over multiple contracts, each of which is parsed by, for example, the predictive model platform 200 in FIG. 2) using the described user interfaces.

In yet another example, an artist's contract specifies a predetermined share of an overall income stream that can include royalty income, income from performances, licensing revenue etc. However, the funding arrangement that the artist has committed to may specify a funding fee that applies to the gross income stream. For example, despite an artist being promised 80% of their overall income stream, if the funding agreement specifies a 14% funding fee, then the artist would receive 80% of every 86 cents (instead of 80% of every $1). Some disclosed embodiments incorporate any and all fee arrangements specified in the contracts to determine artist compensation in both short-and long-term horizons.

As discussed above, and unlike conventional platforms (e.g., Songtrust, Kobalt Music, Vydia), which focus primarily on royalty collection, reporting, or basic financial analytics, the disclosed embodiments leverage machine learning (ML) models to analyze, interpret, and visualize complex music contracts and their financial implications. Specifically, the system parses bespoke contract documents using natural language processing, extracts industry-standard and custom terms, and integrates these with predictive financial models to forecast artist earnings and cashflows under multiple scenarios—including different streaming revenue models (such as pro-rata and user-centric). This allows artists, labels, and rights holders to compare contracts quantitatively, understand the impact of contractual advances, recoupment schedules, and royalties over time, and make better informed business decisions—all in a manner that is rooted in computational analysis rather than subjective interpretation.

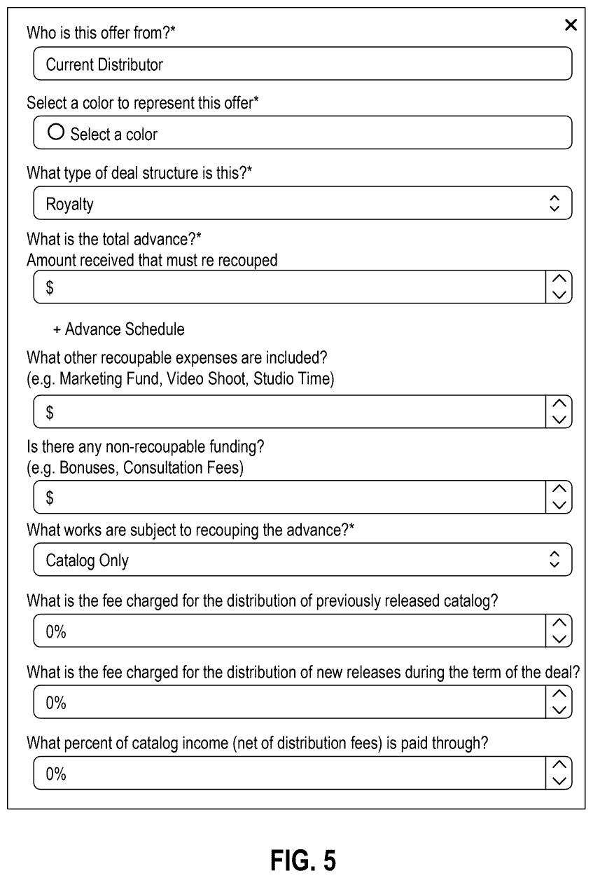

FIGS. 5-12B show example screenshots of the graphical user interface (GUI) that enable artists and independent labels to determine revenue estimates for multiple contracts for both short-term and long-term horizons. For the discussion above and in the following example interfaces, the following definitions and terminology are adopted to ensure an equitable comparison across contracts.
Total Deal Value: A summation of all value being provided by the financing party through advances, bonuses, and other sources (e.g. marketing fund, video shoot, etc.).
Advances: The amount of money provided as an advance on music royalties.
Other Recoupable Funding: Other funding provided that is subject to repayment.
Non-Recoupable Funding: Funding provided that does not need to be repaid.
Effective Recoupment Rate: The effective percentage of income that is applied to paying down the advance. This effective percentage considers the distribution fee that may also be charged to the artist.
Time to Recoupment: The amount of time which it will take the artist or independent artist to recoup all repayable amounts.
Effective Term End: The amount of time until the artist of independent label is non-longer subject to any terms of the contract.
Label/Distribution Fee: The amount of money charged by the distribution company or label for the distribution of the artists or independent labels music to digital streaming platforms (DSPs).
Funder Share Pre-Recoupment: The amount of money that the funding party will receive and recognize of “profit” prior to the deal recouping.
Funder Share Post-Recoupment: The amount of money that the funding party will receive and recognize of “profit” after the deal has recouped.
Total Cost of Funding: The total amount of money given up by the artist or independent label to secure the initial funding.
Annual Percentage Rate (APR): The yearly cost of funding to the artist or independent label. It is calculated as (((Total Cost of Funding÷Funding Amount)÷Number of days until effective term end)×365).
Ten Year Overview: Additional financial statistics after 10 years upon deal signing.
Remaining Recoupable Balance: Remaining balance to be repaid after 10 years.
Amount Paid (excluding advances): The amount of money paid through to the artist in the first 10 years excluding all advances made.
Total Paid: The total amount of money paid to the artist over the next 10 years.
Net Present Value (NPV): This calculation finds the current value of the next 10 years stream of money the artist or independent label will receive at an 8% discount rate.
Annual Cashflow Graph/Table: A bar chart (or table) of the income the artist or independent label will receive in each year over the next 20 years.
Cumulative Cashflow: A line graph (or table) of the total income the artist or independent label will have received in each year over the next 20 years.
Recoupment Schedule: A line graph (or table) of the remaining balance that remains for each year over the next 20 years.
Payment Breakdown: A stacked bar chart for each deal representing the percentage of revenue paid to each party prior to the deals recoupment and after the deals recoupment.
Projections: A bar (annual) or line (cumulative) chart of the raw underlying cashflow predictions of the artist or independent label.

FIG. 5 illustrates an example user interface for entering granular contract details. This form allows users (e.g., artists or independent label representatives) to enter specific conditions of various music industry agreements, including funding, expenses (both recoupable and non-recoupable), distribution deals, and catalog sales. By capturing granular and standardized data, the system can accurately overlay these terms on predicted cashflows (e.g., the distribution of predictions), allowing for an “apples-to-apples” comparison of different deals. This helps artists and independent labels thoroughly assess the financial implications of each contract, promoting transparency. As shown in FIG. 5, the form provides a detailed data entry capability that underpins this tool's ability to generate precise financial models and visualizations, aiding in comprehensive financial decision-making. In some embodiments, the form shown in FIG. 5 is automatically populated based on the described ML models parsing (e.g., using natural language processing) a contract, and extracting the required values for the contract terms and fields.

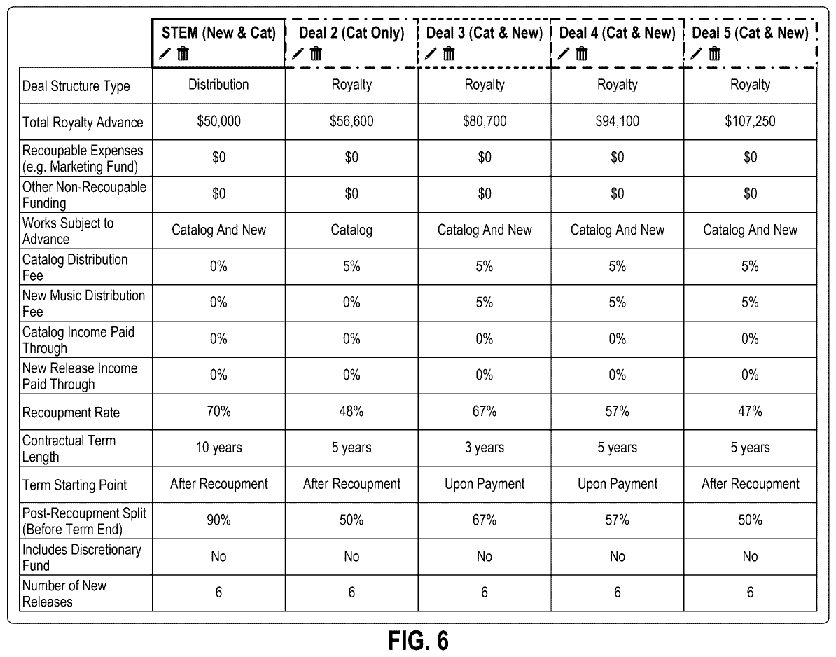

FIG. 6 illustrates an example user interface for displaying side-by-side deal terms, and enabling a comparison between a deal from Stem Disintermedia (STEM) and four other deals (Deal 2 through Deal 5). As shown therein, the comparison covers a range of key financial statistics, which include the deal structure type (e.g., distribution or royalty), advances, other recoupable funding, non-recoupable funding, and the effective recoupment rate. The comparison further incorporates the works that are subject to the advance (e.g., existing or new) as well as the number of new releases. This comprehensive structure provides users with a detailed evaluation of various financial deals, facilitating a clear understanding of the different terms and enabling well-informed decision-making on the part of the artist.

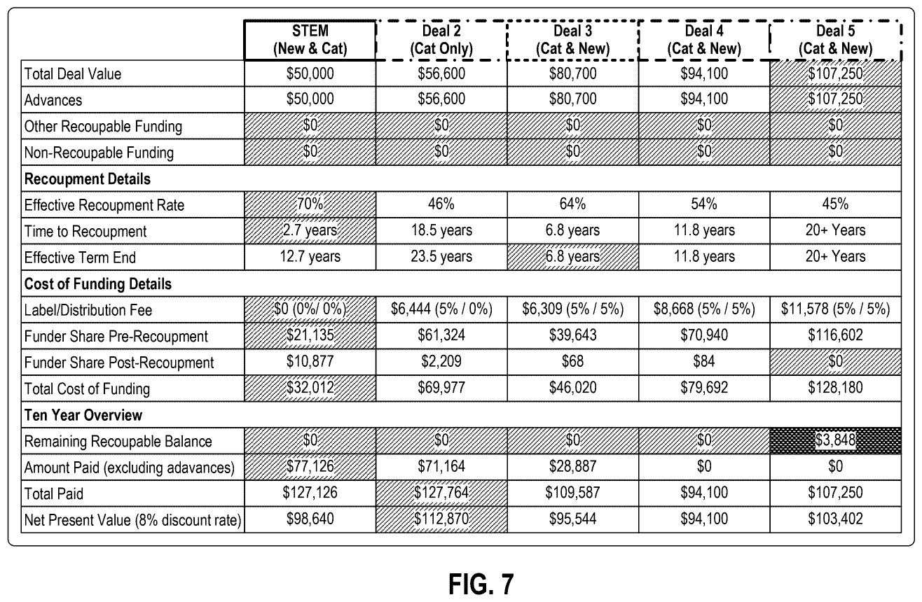

FIG. 7 illustrates an example user interface for displaying key financial statistics. As shown therein, the key financial metrics relevant to music industry deals include total deal value, advances, other recoupable funding, non-recoupable funding, the effective recoupment rate, time to recoupment, effective term end, label/distribution fee, funder share pre-recoupment and post-recoupment, total cost of funding, annual percentage rate (APR), and a ten-year overview. This interface additionally shows that the most advantageous options for the artist (and in each of the metrics) are highlighted to enable the artist to evaluate various financial terms and help inform their financial decisions more effectively.

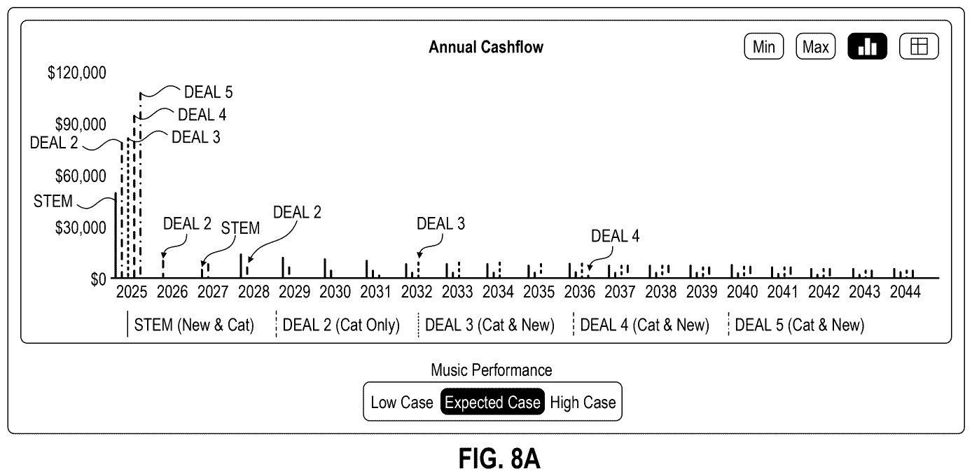

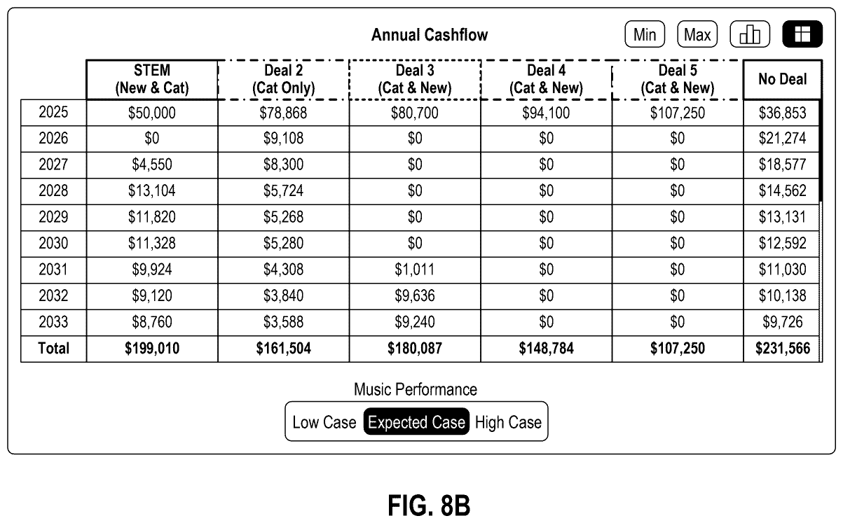

FIGS. 8A and 8B illustrate example user interfaces for displaying annual cashflow in a graph and a table, respectively. As shown therein, the estimated annual cashflow is shown for each of the deals being considered by the artist as a bar graph (FIG. 8A) and in tabular form (FIG. 8B), with the latter format allowing for a granular and precise examination of the annual income, breaking it down into specific years for clearer insight and financial planning. The interface is able to provide the artist with financial options that can range from significant up-front (or year one) revenue compared to a more robust revenue stream distributed over multiple years. Additionally, the tabular format in FIG. 8B also provides information for the scenario in which no contract is signed by the artist.

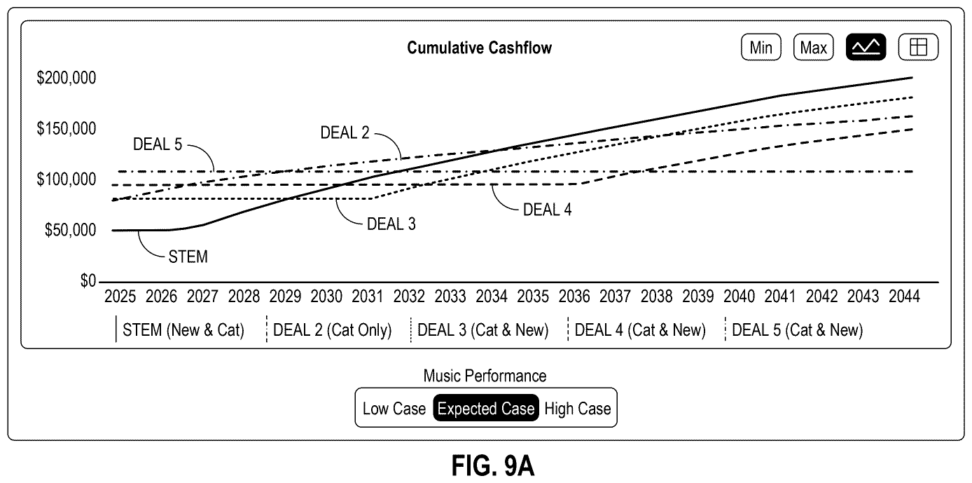

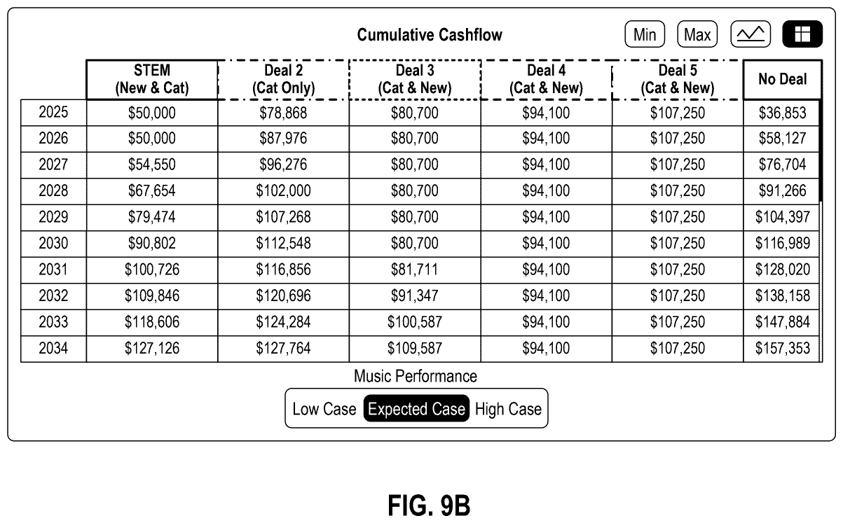

FIGS. 9A and 9B illustrate example user interfaces for displaying cumulative cashflow to the artist or independent label in a graph or a table, respectively. These interfaces are substantively identical to the interfaces shown in FIGS. 8A and 8B, respectively, but provide the cumulative cashflow estimate (instead of the annual cashflow estimate in FIGS. 8A and 8B).

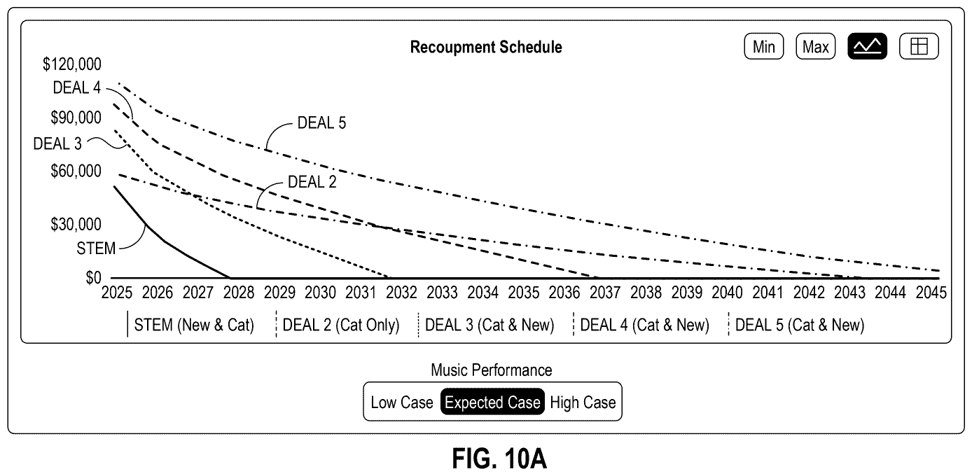

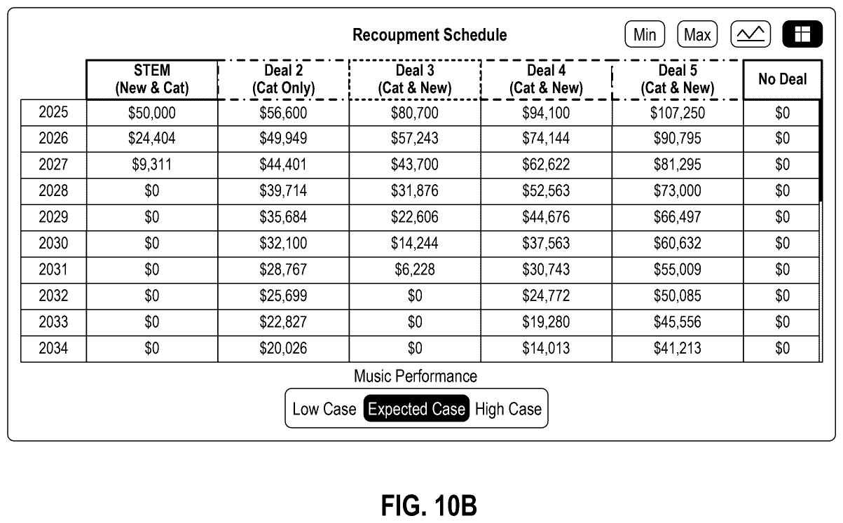

FIGS. 10A and 10B illustrate example user interfaces for displaying recoupment schedules in a graph and a table, respectively. These interfaces are substantively identical to the interfaces shown in FIGS. 8A and 8B, respectively, but provide the recoupment schedules (as compared to the annual cashflow estimate in FIGS. 8A and 8B).

FIG. 11 illustrates an example user interface for displaying payment splits. As shown therein, a stacked bar chart illustrate the different portions of income allocated to each party both before and after the total recoupment of the deal. The chart categorizes the payments into sections that include advances, other recoupable funding, and non-recoupable funding, allowing users to comprehend the financial dynamics and how the revenue is divided at different stages of the contract. This format helps to clarify the financial implications and earning distributions, ensuring that all parties understand how the income is split over the term of the deal and beyond.

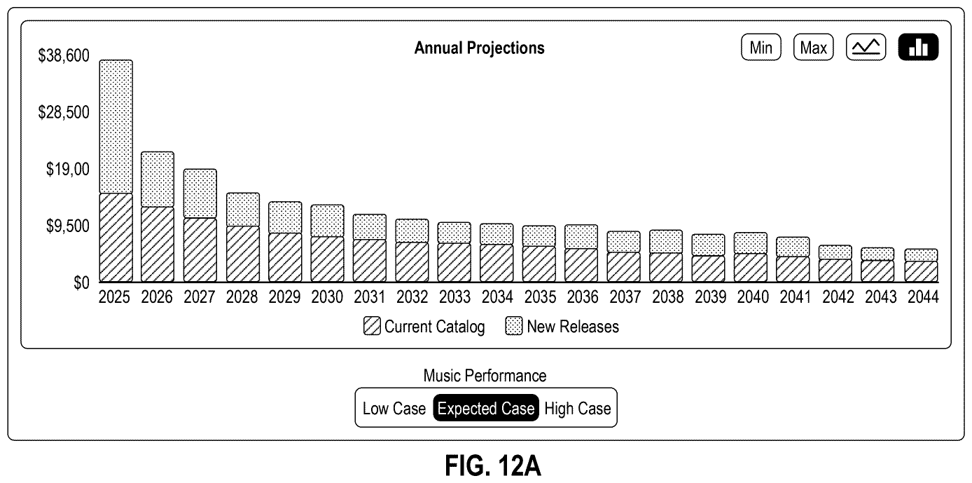

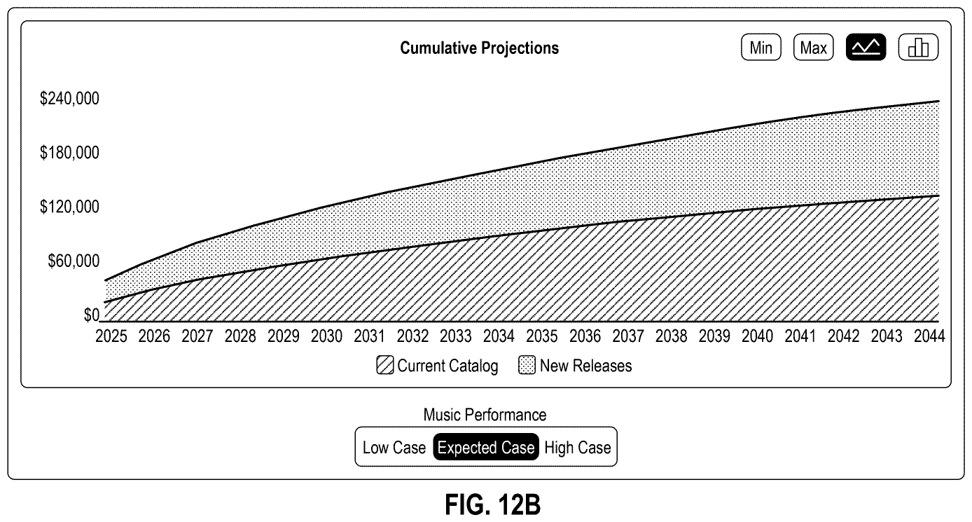

FIGS. 12A and 12B illustrate example user interfaces for annual and cumulative music performance predictions, respectively. The interfaces illustrate the projected performance metrics of an artist's or label's music on a yearly basis (FIG. 12A), which aids in understanding yearly trends and potential peaks in performance over a specified period, and a cumulative music performance predictions graph (FIG. 12B), which aggregates the annual data to show the overall cumulative performance, providing insights into long-term trends and the overall trajectory of the music's success. These visualizations are critical for evaluating future performance potential and help in making informed financial decisions by offering both a yearly and an aggregated long-term view of music performance projections.

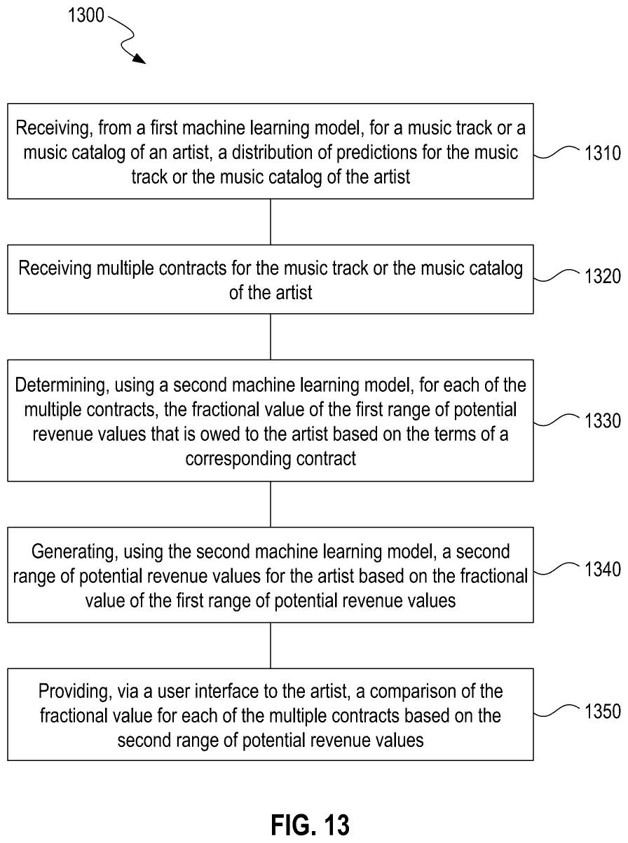

FIG. 13 is a flowchart representation of a method 1300 for determining music artist compensation alternatives. The method 1300 includes, receiving (1310), from a first machine learning model, for a music track or a music catalog of an artist, a distribution of predictions for the music track or the music catalog of the artist, where the distribution of predictions indicates a first range of potential revenue values associated with a low, medium, and high probability of success of the music track or the music catalog; receiving (1320) multiple contracts for the music track or the music catalog of the artist, where each contract of the multiple contracts comprises terms associated with determining a fractional value of a potential revenue value associated with the music track or the music catalog; determining (1330), using a second machine learning model, for each of the multiple contracts, the fractional value of the first range of potential revenue values that is owed to the artist based on the terms of a corresponding contract; generating (1340), using the second machine learning model, a second range of potential revenue values for the artist based on the fractional value of the first range of potential revenue values; and providing (1350), via a user interface to the artist, a comparison of the fractional value for each of the multiple contracts based on the second range of potential revenue values.

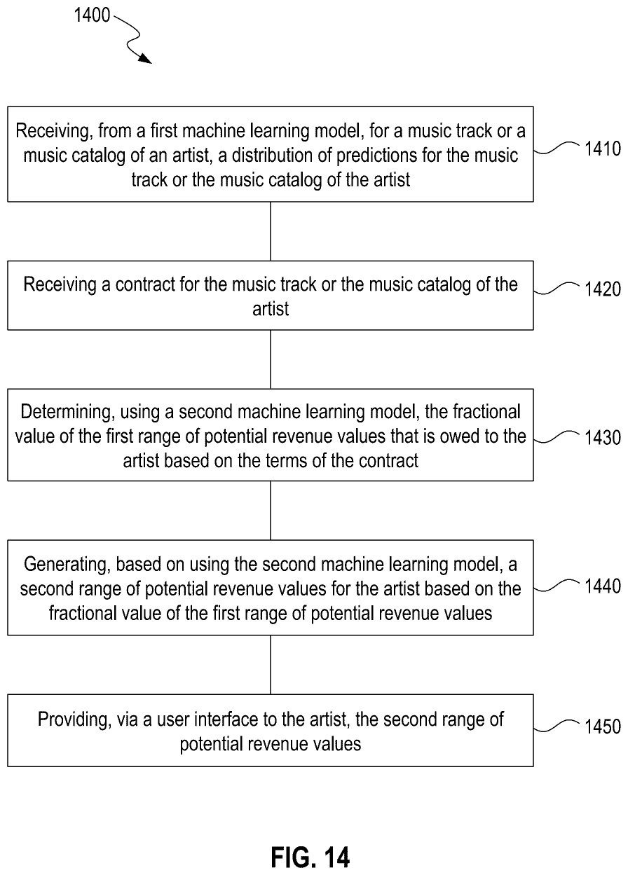

FIG. 14 is a flowchart representation of a method 1400 for determining music artist compensation. The method 1400 includes, receiving (1410), from a first machine learning model, for a music track or a music catalog of an artist, a distribution of predictions for the music track or the music catalog of the artist, where the distribution of predictions indicates a first range of potential revenue values associated with a low, medium, and high probability of success of the music track or the music catalog; receiving (1420) a contract for the music track or the music catalog of the artist, where the contract comprises terms associated with determining a fractional value of a potential revenue value associated with the music track or the music catalog; determining (1430), using a second machine learning model, the fractional value of the first range of potential revenue values that is owed to the artist based on the terms of the contract; generating (1440), based on using the second machine learning model, a second range of potential revenue values for the artist based on the fractional value of the first range of potential revenue values; and providing (1450), via a user interface to the artist, the second range of potential revenue values.

In some embodiments of the above-described methods 1300 and 1400, using the second machine learning model to generate the second range of potential revenue values comprises parsing the terms of each of the multiple contracts to identify a set of revenue-sharing requirements from the corresponding contract, and determining, for the corresponding contract, the second range of potential revenue values by applying the set of revenue-sharing requirements of the corresponding contract to the first range of potential revenue values.

In some embodiments, applying the set of revenue-sharing requirements to the first range of potential revenue values comprises determining, for each potential revenue value in the first range of potential revenue values, the fractional value of each potential revenue value owed to the artist based on at least one metric derived from the set of revenue-sharing requirements. In some examples, the set of revenue-sharing requirements comprises one or more of a type of deal structure, advances provided to the artist, a list of recoupable expenses, or a list of non-recoupable funding. In other examples, the at least one metric comprises one or more of an advance amount provided to the artist, a distribution fee for the music track or the music catalog, a contractual term length, a term starting point.

In some embodiments, the comparison includes, for each of the multiple contracts, one or more of an annual cashflow, a cumulative cashflow, a recoupment schedule, an annual projection, a cumulative projection, or a payment distribution for the artist.

In some embodiments, the first machine learning model is configured to generate, based on metadata of the artist, the distribution of predictions, and wherein the first machine learning model is trained based on a training dataset and a set of loss functions. In some examples, the training dataset comprises at least streaming metrics, artist metrics, or social media metrics about a plurality of artists over a period of time. In other examples, different values are assigned to the set of loss functions such that a first prediction exceeding a target value is given a different weight as compared to a second prediction below the target value.

In some embodiments, the first range of potential revenue values includes a first potential revenue value from at least one streaming music platform. In some examples, the fractional value is based on a pro-rata model, a user-centric model, or a combination of the pro-rata model and the user-centric model being applied to a total revenue of the at least one streaming music platform over a period of time.

In some embodiments, the first range of potential revenue values includes a first potential revenue value from an advance amount provided to the artist and a second potential revenue value from a royalty income stream, and wherein the fractional value is based on a percentage of the royalty income stream that has been allocated to paying off the advance amount.

In some embodiments, the first range of potential revenue values comprises a predetermined percentage of an overall income stream and the terms comprise a funding fee, and wherein the fractional value is based on applying the funding fee to the overall income stream prior to applying the predetermined percentage to the overall income stream.

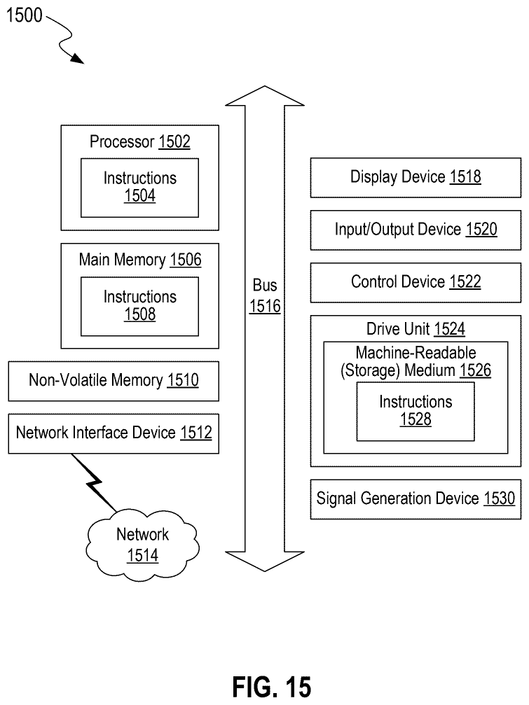

FIG. 15 is a block diagram that illustrates an example of a computer system 1500 in which at least some operations described herein can be implemented. As shown, the computer system 1500 can include: one or more processors 1502, main memory 1506, non-volatile memory 1510, a network interface device 1512, video display device 1518, an input/output device 1520, a control device 1522 (e.g., keyboard and pointing device), a drive unit 1524 that includes a storage medium 1526, and a signal generation device 1530 that are communicatively connected to a bus 1516. The bus 1516 represents one or more physical buses and/or point-to-point connections that are connected by appropriate bridges, adapters, or controllers. Various common components (e.g., cache memory) are omitted from FIG. 15 for brevity. Instead, the computer system 1500 is intended to illustrate a hardware device on which components illustrated or described relative to the examples of the figures and any other components described in this specification can be implemented.

The computer system 1500 can take any suitable physical form. For example, the computing system 1500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 1500. In some implementation, the computer system 1500 can be an embedded computer system, a system-on-chip (SOC), a single-board computer system (SBC) or a distributed system such as a mesh of computer systems or include one or more cloud components in one or more networks. Where appropriate, one or more computer systems 1500 can perform operations in real-time, near real-time, or in batch mode.

The network interface device 1512 enables the computing system 1500 to mediate data in a network 1514 with an entity that is external to the computing system 1500 through any communication protocol supported by the computing system 1500 and the external entity. Examples of the network interface device 1512 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 1506, non-volatile memory 1510, machine-readable medium 1526) can be local, remote, or distributed. Although shown as a single medium, the machine-readable medium 1526 can include multiple media (e.g., a centralized/distributed database and/or associated caches and servers) that store one or more sets of instructions 1528. The machine-readable (storage) medium 1526 can include any medium that is capable of storing, encoding, or carrying a set of instructions for execution by the computing system 1500. The machine-readable medium 1526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 1510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1504, 1508, 1528) set at various times in various memory and storage devices in computing device(s). When read and executed by the processor 1502, the instruction(s) cause the computing system 1500 to perform operations to execute elements involving the various aspects of the disclosure.

Various operations disclosed herein can be implemented using a processor/controller is configured to include, or be couple to, a memory that stores processor executable code that causes the processor/controller carry out various computations and processing of information. The processor/controller can further generate and transmit/receive suitable information to/from the various system components, as well as suitable input/output (IO) capabilities (e.g., wired or wireless) to transmit and receive commands and/or data.

Various information and data processing operations described herein may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media that is described in the present application comprises non-transitory storage media. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A method for determining music artist compensation alternatives, comprising:
receiving, from a first machine learning model, for a music track or a music catalog of an artist, a distribution of predictions for the music track or the music catalog of the artist,
wherein the distribution of predictions indicates a first range of potential revenue values associated with a low, medium, and high probability of success of the music track or the music catalog;
receiving multiple contracts for the music track or the music catalog of the artist,
wherein each contract of the multiple contracts comprises terms associated with determining a fractional value of a potential revenue value associated with the music track or the music catalog;
determining, using a second machine learning model, for each of the multiple contracts, the fractional value of the first range of potential revenue values that is owed to the artist based on the terms of a corresponding contract;
generating, using the second machine learning model, a second range of potential revenue values for the artist based on the fractional value of the first range of potential revenue values; and
providing, via a user interface to the artist, a comparison of the fractional value for each of the multiple contracts based on the second range of potential revenue values.

2. The method of claim 1, wherein using the second machine learning model to generate the second range of potential revenue values comprises:
parsing the terms of each of the multiple contracts to identify a set of revenue-sharing requirements from the corresponding contract; and
determining, for the corresponding contract, the second range of potential revenue values by applying the set of revenue-sharing requirements of the corresponding contract to the first range of potential revenue values.

3. The method of claim 2, wherein applying the set of revenue-sharing requirements to the first range of potential revenue values comprises:
determining, for each potential revenue value in the first range of potential revenue values, the fractional value of each potential revenue value owed to the artist based on at least one metric derived from the set of revenue-sharing requirements.

4. The method of claim 3, wherein the set of revenue-sharing requirements comprises one or more of a type of deal structure, advances provided to the artist, a list of recoupable expenses, or a list of non-recoupable funding.

5. The method of claim 3, wherein the at least one metric comprises one or more of an advance amount provided to the artist, a distribution fee for the music track or the music catalog, a contractual term length, a term starting point.

6. The method of claim 1, wherein the comparison includes, for each of the multiple contracts, one or more of an annual cashflow, a cumulative cashflow, a recoupment schedule, an annual projection, a cumulative projection, or a payment distribution for the artist.

7. The method of claim 1, wherein the first machine learning model is configured to generate, based on metadata of the artist, the distribution of predictions, and wherein the first machine learning model is trained based on a training dataset and a set of loss functions.

8. The method of claim 7, wherein the training dataset comprises at least streaming metrics, artist metrics, or social media metrics about a plurality of artists over a period of time.

9. The method of claim 7, wherein different values are assigned to the set of loss functions such that a first prediction exceeding a target value is given a different weight as compared to a second prediction below the target value.

10. The method of claim 1, wherein the first range of potential revenue values includes a first potential revenue value from at least one streaming music platform.

11. The method of claim 10, wherein the fractional value is based on a pro-rata model, a user-centric model, or a combination of the pro-rata model and the user-centric model being applied to a total revenue of the at least one streaming music platform over a period of time.

12. The method of claim 1, wherein the first range of potential revenue values includes a first potential revenue value from an advance amount provided to the artist and a second potential revenue value from a royalty income stream, and wherein the fractional value is based on a percentage of the royalty income stream that has been allocated to paying off the advance amount.

13. The method of claim 1, wherein the first range of potential revenue values comprises a predetermined percentage of an overall income stream and the terms comprise a funding fee, and wherein the fractional value is based on applying the funding fee to the overall income stream prior to applying the predetermined percentage to the overall income stream.

14. A system for determining music artist compensation, comprising:
at least one processor configured to:
receive, from a first machine learning model, for a music track or a music catalog of an artist, a distribution of predictions for the music track or the music catalog of the artist,
wherein the distribution of predictions indicates a first range of potential revenue values associated with a low, medium, and high probability of success of the music track or the music catalog;
receive a contract for the music track or the music catalog of the artist,
wherein the contract comprises terms associated with determining a fractional value of a potential revenue value associated with the music track or the music catalog;
determine, using a second machine learning model, the fractional value of the first range of potential revenue values that is owed to the artist based on the terms of the contract;
generate, based on using the second machine learning model, a second range of potential revenue values for the artist based on the fractional value of the first range of potential revenue values; and
provide, via a user interface to the artist, the second range of potential revenue values.

15. The system of claim 14, wherein the at least one processor is configured, as part of generating the second range of potential revenue values, to:
parse the terms of the contract to identify a set of revenue-sharing requirements; and
determine the second range of potential revenue values by applying the set of revenue-sharing requirements of the contract to the first range of potential revenue values.

16. The system of claim 15, wherein the at least one processor is configured, as part of applying the set of revenue-sharing requirements to the first range of potential revenue values, to:
determine, for each potential revenue value in the first range of potential revenue values, the fractional value of each potential revenue value owed to the artist based on at least one metric derived from the set of revenue-sharing requirements.

17. The system of claim 16, wherein the set of revenue-sharing requirements comprises one or more of a type of deal structure, advances provided to the artist, a list of recoupable expenses, or a list of non-recoupable funding.

18. The system of claim 16, wherein the at least one metric comprises one or more of an advance amount provided to the artist, a distribution fee for the music track or the music catalog, a contractual term length, a term starting point.

19. The system of claim 14, wherein the first machine learning model is configured to generate, based on metadata of the artist, the distribution of predictions, wherein the first machine learning model is trained based on a training dataset and a set of loss functions, wherein the training dataset comprises streaming metrics, artist metrics, or social media metrics about a plurality of artists over a period of time, and wherein different values are assigned to the set of loss functions such that a first prediction exceeding a target value is given a different weight as compared to a second prediction below the target value.

20. The system of claim 14, wherein the first range of potential revenue values includes a first potential revenue value from at least one streaming music platform, and wherein the fractional value is based on a pro-rata model, a user-centric model, or a combination of the pro-rata model and the user-centric model being applied to a total revenue of the at least one streaming music platform over a period of time.
